(19) United States
(12) Patent Application Publication
(10) Pub. No.: US 2014/0136580 A1
(43) Pub. Date: May 15, 2014

(54) METHOD AND SYSTEM FOR OPENING FILE AND COMPUTER READABLE STORAGE MEDIUM STORING THE METHOD

(71) Applicant: INSTITUTE FOR INFORMATION INDUSTRY, TAIPEI (TW)

(72) Inventor: Yu-Wei CHUANG, Taichung City (TW)

(73) Assignee: INSTITUTE FOR INFORMATION INDUSTRY, TAIPEI (TW)

(21) Appl. No.: 13/716,201

(22) Filed: Dec. 17, 2012

(30) Foreign Application Priority Data
Nov. 9, 2012 (TW) 101141824

(51) Int. Cl. G06F 17/30

(52) U.S. Cl. CPC G06F 17/30194
USPC 707/827

(57) ABSTRACT

A method for opening a file includes the following step: a web page is provided to a client device for being displayed on the client device. The web page is utilized to keep detecting if there is a request for opening a file. When the request is detected, the client device is utilized to transmit the request and the file. File information of the file is identified. A target application server, which has an ability to execute the file, is selected from several candidate application servers in an application server pool according to the file information. The target application server is utilized to execute the file, such that at least one execution frame about executing the file is generated. The at least one execution frame is transmitted to the client device, such that the client device displays the at least one execution frame.

### RELATED APPLICATIONS

This application claims priority to Taiwan Application Serial Number 101141824, filed Nov. 9, 2012, which is herein incorporated by reference.

### BACKGROUND

1. Technical Field

The present invention relates to a method and system for opening a file and a computer readable storage medium for storing the method.

2. Description of Related Art

As digital age comes, many people utilize electrical devices to acquire information, knowledge and communicate with others. Hence, information about various domains is converted into digital format.

Different file formats are developed for different domains, which leads that different application programs may be needed for opening files with different file formats. As a result, it is hard for users to choose right application programs to open files.

In the prior arts, corresponding filename extensions may be registered during installing application programs, or operating systems (OS) may provide suggestions. However, a filename extension may not be recognized since OS may not store related information or no corresponding application program is installed.

Hence, there is a need to assist users to open various types of file.

### SUMMARY

According to one embodiment of this invention, a method for opening a file is disclosed to open a file utilizing a remote application server and transmits a frame about the execution to a client for display. The method includes the following steps:

(a) a web page is provided to a client device for being displayed on the client device.

(b) the web page is utilized to keep detecting if here is a request for opening a file.

(c) the client device is utilized to transmit the request and the file when the request is detected.

(d) file information of the file is identified.

(e) a target application server, which has an ability to execute the file, is searched from several candidate application servers in an application server pool according to the file information.

(f) the target application server is utilized to execute the file, such that at least one execution frame about executing the file is generated.

(g) the at least one execution frame is transmitted to the client device, such that the client device displays the at least one execution frame.

According to another embodiment of this invention, a computer-readable storage medium storing a computer program for executing the steps of the aforementioned method for opening a file is provided. Steps of the method are as disclosed above.

According to another embodiment of this invention, a system far opening a file is disclosed. The system includes a network card and a processing unit. The processing unit is electrically connected with the network card. The network card builds a connection with a network. The processing unit includes a web-page providing module, an identifying module, a server selecting module, an executing module and a frame transmitting module. The web-page providing module provides a web page to a client device through the network for being displayed on the client device. The web page keeps detecting if there is a request for opening a file. When the request is detected and the client device transmits the request and the file to the system, the identifying module identifies file information of the file. The server selecting module selects a target application server, which has an ability to execute the file, from several candidate application servers in an application server pool according to the file information. The executing module utilizes the target application server to execute the file, such that at least one execution frame about executing the file is generated. The frame transmitting module transmits the at least one execution frame to the client device, such that the client device displays the at least one execution frame.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a flow diagram of a method for opening a file according to one embodiment of this invention; and

FIG. 2 illustrates a block diagram of a system for opening a file according to an embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

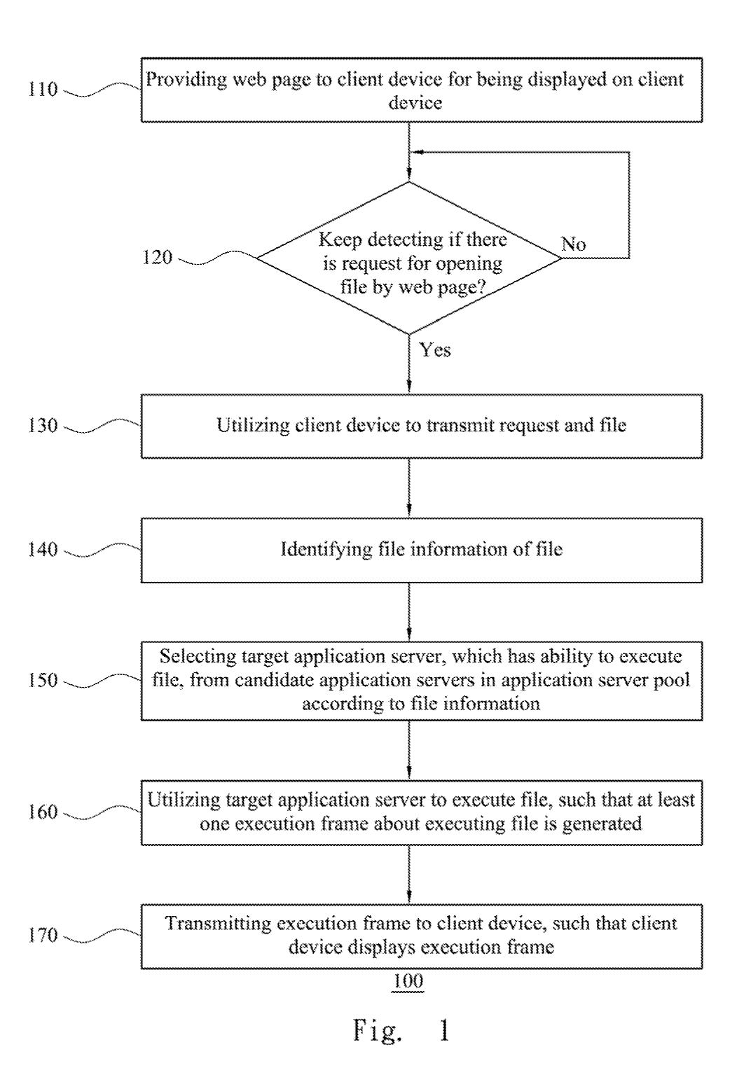

Referring to FIG. 1, a flow diagram will be described that illustrates a method for opening a file according to one embodiment of this invention. In the method, a file is opened utilizing a remote application server and a frame about the execution is transmitted to a client for display. The method may take the form of a computer program product stored on a computer-readable storage medium having computer-readable instructions embodied in the medium. Any suitable storage medium (such as non-transitory medium) may be used including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs) and digital versatile disc read only memories (DVD-ROMs); and magnetic storage devices such as hard disk drives (HDD) and floppy disk drives.

The method 100 includes the following steps:

At step 110, a web page is provided to a client device for being displayed on the client device.

At step 120, the web page is utilized to keep detecting if there is a request for opening a file. In some embodiments, the web page provided at step 100 may include an interface program to monitor a file-triggering event, such that the detection at step 120 can be performed. In addition, in some embodiments, some specific operations on the web page (such as single-click, a double-click, drag or any other user-interface operation) can be defined for generating a request for opening a file.

When there is no request detected, detection of step 120 is kept performed.

At step 130, when the request is detected, the client device is utilized to transmit the request and the file to a server device applying the method 100.

At step 140, file information of the file is identified.

At step 150, a target application server, which has an ability to execute the file, is searched from several candidate application servers in an application server pool according to the file information.

At step 160, the target application server is utilized to execute the file, such that at least one execution frame about executing the file is generated.

At step 170, the at least one execution frame is transmitted to the client device, such that the client device displays the at least one execution frame. In some embodiments, a remote display protocol or any other image transmission protocol can be utilized to transmit the execution frame to the client device for performing step 170. Therefore, a user can open files through the web page without knowing which program is able to opening the files in advance. In addition, the web page is a common format for different operating systems, which leads that the method 100 can support cross-platform. Furthermore, even if the client device is installed with an operating system, which does not support the file to be opened, the file can be stilled opened with the remote application server.

In some embodiments of step 140, a filename extension of the file can he captured. Subsequently, the file information can be generated according to the filename extension for step 150 to select the target application server, which has the ability to execute the file. in some embodiments of step 150, a candidate application, which supports the filename extension of the file, can be taken as the target application server.

In some other embodiments of step 140, a file format of the file can be analyzed. For example, information embedded in a header of the file, a tag of the file or any other format related information of the file can be read for analyzing the file format of the file. Subsequently, the file information can be generated according to the file format for step 150 to select the target application server, which has the ability to execute the file.

In still other embodiments, a multipurpose Internet mail extensions (MIME) type of the file can be identified to be taken as the file information. Hence, in some embodiments of step 150, the target application server can be selected according to the MIME type of the file.

In some other embodiments of step 150, a user-definition or rating database can be searched according to the file information to generate a searching result, and the target application server can be selected according to the searching result. In some embodiments, address information of the user-definition or rating database can be pre-stored for connection. The user-definition or rating database can record settings corresponding to different types of files. Furthermore, the user-definition or rating database may further record the rating of candidate application servers to execute different types of filed, which can be taken as a factor for selection at step 150.

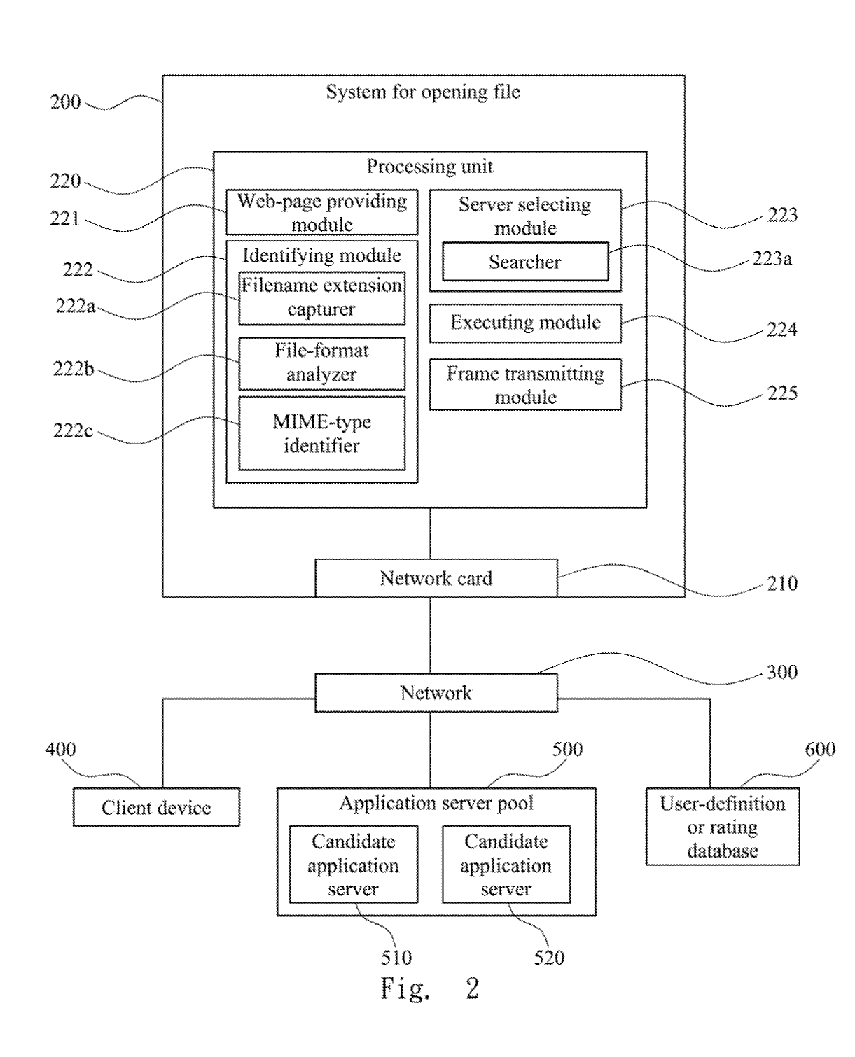

FIG. 2 illustrates a block diagram of a system for opening a file according to an embodiment of this invention. The system 200 includes a network card 210 and a processing unit 220, which are electrically connected with each other. In one embodiment of this invention, the processing unit 220 may be provided by a single computer, machine, server or a processing unit of any other electrical device. In another embodiment of this invention, the processing unit 220 may be discretely provided by several computers, machines, servers, or processing units of other electrical devices or combination thereof. The network card 210 builds a connection with a network 300 utilizing a wired or wireless network communication protocol.

The processing unit 220 includes a web-page providing module 221, an identifying module 222, a server selecting module 223, an executing module 224 and a frame transmitting module 225. The web-page providing module 221 provides a web page to a client device 400 through the network 300 for being displayed on the client device 400. The displayed web page keeps detecting if there is a request for opening a file. The web page provided by the web-page providing module 221 may include an interface program to monitor a file-triggering event, such that detecting if there is a request for opening a file can be performed. In addition, in some embodiments, some specific operations on the web page (such as single-click, a double-click, drag or any other user-interface operation) can be defined for generating a request for opening a file.

Hence, in one scenario of this invention, when a user wants to open a file, he/she can utilize the client device 400 to connect to the system 200. When the connection is built, the web-page providing module 221 may provide a web page to a client device 400 through the network 300 according to the connection information. Subsequently, the user can operate through the web page displayed on the client device 400, such that the client device 400 generates a corresponding request for opening a file.

When the request is detected and the client device 400 transmits the request and the file to the system 200, the identifying module 222 identifies file information of the file.

The server selecting module 223 selects a target application server, which has an ability to execute the file, from several candidate application servers 510, 520 in an application server pool 500 according to the file information. In this embodiment, if the candidate application server 510 is able to execute the file, the candidate application server 510 may be selected as the target application server.

The executing module 224 utilizes the target application server 510 to execute the file, such that at least one execution frame about executing the file is generated.

The frame transmitting module 225 transmits the at least one execution frame to the client device 400, such that the client device 400 displays the at least one execution frame. The frame transmitting module 225 may utilize a remote display protocol or any other image transmission protocol to transmit the execution frame to the client device 400. Therefore, a user can open files through the web page without knowing which program is able to opening the files in advance. In addition, the web page is a common format for different operating systems. As a result, no matter what operating system is installed at the client device 400, the system 200 can always be utilized to open the files for the client device 400. Furthermore, even if the client device 400 is installed with a operating system, which does not support the file to be opened, the file can be stilled opened with the system 200.

In some embodiments, the identifying module 222 may include a filename extension capturer 222a. The filename extension capturer 222a captures a filename extension of the file. Hence, the identifying module 222 may generate the file information according to the filename extension.

In some other embodiments, the identifying module 222 may include a file-format analyzer 222b. The file-format analyzer 222b analyzes a file format of the file. For example, the file-format analyzer 222b may read information embedded in a header of the file, a tag of the file or any other format related information of the file for analyzing the file format of the file. Subsequently, the identifying module 222 generates the file information according to the file format. The MIME-type identifier identifies a MIME type of the file to be taken as the file information.

In some other embodiments, the identifying module 222 may include an MIME-type identifier 222c.

Furthermore, the server selecting module 223 may include a searcher 223a. The searcher searches a user-definition or rating database 600 through the network 600 according to the file information to generate a searching result, and selects the target application server according to the searching result.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for opening a file comprising:
(a) providing a web page to a client device for being displayed on the client device;
(b) utilizing the web page to keep detecting if there is a request for opening a file;
(c) utilizing the client device to transmit the request and the file when the request is detected;
(d) identifying file information of the file;
(e) selecting a target application server, which has an ability to execute the file, from a plurality of candidate application servers in an application server pool according to the file information;
(f) utilizing the target application server to execute the file, such that at least one execution frame about executing the file is generated; and
(g) transmitting the at least one execution frame to the client device, such that the client device displays the at least one execution frame.

2. The method of claim 1, wherein step (d) comprises:
capturing a filename extension of the file; and
generating the file information according to the filename extension.

3. The method of claim 1, wherein step (d) comprises:
analyzing a file format of the file; and
generating the file information according to the file format.

4. The method of claim 1 wherein step (e) comprises:
searching a user-definition or rating database according to the file information to generate a searching result, and selecting the target application server according to the searching result.

5. The method of claim 1, wherein step (d) comprises:
identifying a multipurpose internet mail extensions (MIME) type of the file to be taken as the file information.

6. A system for opening a file comprising:
a network card for building a connection with a network; and
a processing unit, electrically connected with the network card, wherein the processing unit comprises:
a web-page providing module for providing a web page to a client device through the network for being displayed on the client device, wherein the web page keeps detecting if there is a request for opening a file;
an identifying module for identifying file information of the file when the request is detected and the client device transmits the request and the file to the system;
a server selecting module for selecting a target application server, which has an ability to execute the file, from a plurality of candidate application servers in an application server pool according to the file information;
an executing module for utilizing the target application server to execute the file, such that at least one execution frame about executing the file is generated; and
a frame transmitting module for transmitting the at least one execution frame to the client device, such that the client device displays the at least one execution frame.

7. The system of claim 6, wherein the identifying module comprises:
a filename extension capturer for capturing a filename extension of the file, wherein the identifying module generates the file information according to the filename extension.

8. The system of claim 6, wherein the identifying module comprises:
a file-format analyzer for analyzing a file format of the file, wherein the identifying module generates the file information according to the file format.

9. The system of claim 6, wherein the server selecting module comprising:
a searcher for searching a user-definition or rating database according to the file information to generate a searching result, and selecting the target application server according to the searching result.

10. The system of claim 6, wherein the identifying module comprises:
an MIME-type identifier for identifying a MIME type of the file to be taken as the file information.

11. A non-transitory computer readable storage medium with a computer program to execute a method for opening a file, wherein the method comprises:
(a) providing a web page to a client device for being displayed on the client device;
(b) utilizing the web page to keep detecting if there is a request for opening a file;
(c) utilizing the client device to transmit the request and the file when the to request is detected;
(d) identifying file information of the file;
(e) selecting a target application server, which has an ability to execute the file, from a plurality of candidate application servers in an application server pool according to the file information;
(f) utilizing the target application server to execute the file, such that at least one execution frame about executing the file is generated; and
(g) transmitting the at least one execution frame to the client device, such that the client device displays the at least one execution frame.
